(19) United States
(12) Patent Application Publication
(10) Pub. No.: US 2025/0310504 A1
(43) Pub. Date: Oct. 2, 2025

(54) OPTICAL DEVICE, GLASSES COMPRISING THE OPTICAL DEVICE, OPTICAL INSTRUMENT OR HEAD-UP DISPLAY COMPRISING THE OPTICAL DEVICE, AND METHOD FOR ADJUSTING A COLOR RATIO OF A LASER LIGHT

(71) Applicant: Robert Bosch GmbH, Stuttgart (DE)

(72) Inventor: Christian Adam Grafenburg, Stuttgart (DE)

(21) Appl. No.: 19/053,688

(22) Filed: Feb. 14, 2025

(30) Foreign Application Priority Data
Mar. 28, 2024 (DE) 10 2024 202 999.8

(51) Int. Cl. H04N 13/324; H04N 13/15; H04N 13/257; H04N 13/327

(52) U.S. Cl. CPC H04N 13/324; H04N 13/15; H04N 13/257; H04N 13/327

(57) ABSTRACT

An optical device and method for adjusting a color ratio of a laser light, a laser module emitting laser light having an adjustable color ratio. A light composition of an ambient or scene light is detected, and the color ratio of the laser light is determined depending on the light composition. Glasses, an optical instrument, and a head-up display including the optical device, are also described.

### CROSS REFERENCE

The present application claims the benefit under 35 U.S.C. § 119 of German Patent Application No. DE 10 2024 202 999.8 filed on Mar. 28, 2024, which is expressly incorporated herein by reference in its entirety.

### FIELD

The present invention relates to an optical device, to glasses comprising the optical device, to an optical instrument or head-up display comprising the optical device, and to a method for adjusting a color ratio of a laser light.

### BACKGROUND INFORMATION

Optical devices for generating images using laser light from laser diodes are calibrated once during production with regard to their white point, i.e., the ratio of the radiation intensities of the individual laser diodes.

However, a person's perception of white varies greatly depending on the ambient light. In situations with, for example, particularly warm or cold light, this can result in a white tone produced by the optical device deviating significantly from the white tone in the vicinity of the optical device.

As a result, images or image content superimposed on the environment may not blend seamlessly with the environment or may collide with the environment.

### SUMMARY

The method and the optical device according to the present invention can be used to seamlessly integrate images or augmented image content generated by an optical device well into the environment of the optical device or, alternatively, to make them particularly stand out therefrom.

According to an example embodiment of the present invention, the method for adjusting a color ratio of a laser light provides that a laser module emits laser light having an adjustable color ratio, a light composition of an ambient or scene light being detected, and the color ratio of the laser light being determined depending on the light composition.

The method provides, for example, that the color ratio is generated by a composition of light generated by at least two differently colored color laser diodes arranged in the laser module, the composition being determined depending on the light composition.

The method can provide that correction data for the composition are provided depending on the light composition, the composition being adjusted depending on the correction data.

According to an example embodiment of the present invention, preferably, it is provided that the correction data achieving a match of the white point of the display with the white point of the environment are provided, or that the correction data achieving a deviation of the white point of the display from the white point of the environment are provided. The matching adjusts the display to the environment. The intentional deviation serves to better distinguish between the display and the environment.

The method can provide that an image or image content is generated using the laser light.

According to an example embodiment of the present invention, the optical device comprises a laser module, a sensor for detecting a light composition of an ambient or scene light, in particular a colorimeter, and a computing device, the laser module being designed to emit laser light having an adjustable color ratio, the computing device being designed to determine the color ratio of the laser light depending on the light composition.

It can be provided that the laser module comprises at least two differently colored color laser diodes, the optical device being designed to generate the color ratio by a composition of light generated by the at least two color laser diodes, and the computing device being designed to determine the composition depending on the light composition.

According to an example embodiment of the present invention, it can be provided that the computing device is designed to provide the correction data for the composition depending on the light composition, the optical device comprising a driver for the laser module, which driver is designed to adjust the composition depending on the correction data.

According to an example embodiment of the present invention, it can be provided that the optical device is designed to generate an image or image content using the laser light. This makes the optical device particularly suitable for glasses, an optical instrument, or a head-up display.

Glasses can be provided, in particular data glasses, virtual reality glasses, mixed reality glasses, cycling glasses, diving goggles, safety glasses, or a motorcycle helmet visor, the glasses comprising the optical device.

An optical instrument can be provided, in particular binoculars, a telescope, a microscope, a periscope, a device for ophthalmic examinations, the instrument comprising the optical device.

A head-up display can be provided, in particular for a vehicle or an aircraft, the display comprising the optical device.

Further embodiments of the present invention can be found in the following description and the figures.

### BRIEF DESCRIPTION OF THE DRAWINGS

FIG. 1 is a schematic representation of an optical device, according to an example embodiment of the present invention.

FIG. 2 is a flowchart showing steps of a method for adjusting a color ratio of a laser light, according to an example embodiment of the present invention.

FIG. 3 shows data glasses that comprise the optical device according to an example embodiment of the present invention.

### DETAILED DESCRIPTION OF EXAMPLE EMBODIMENTS

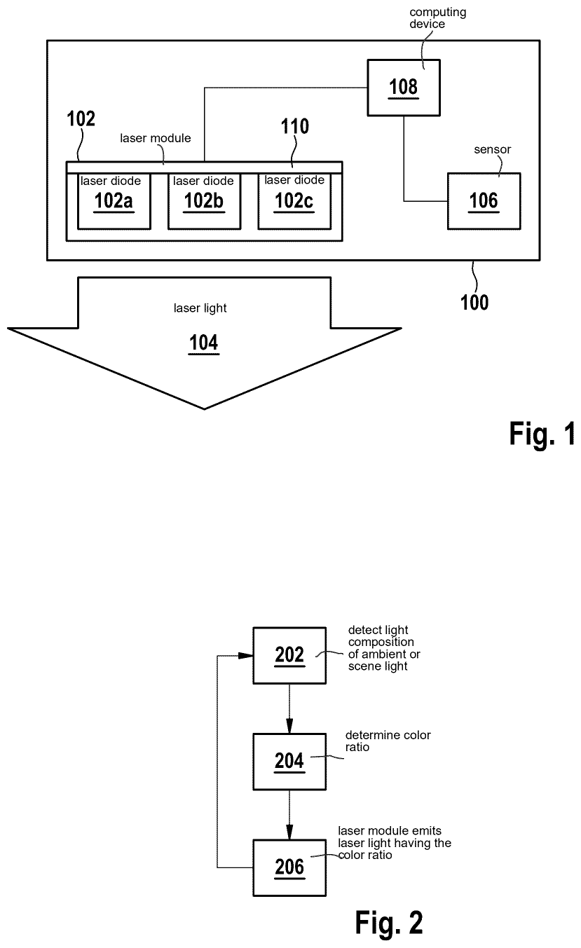

FIG. 1 is a schematic representation of an optical device 100.

The optical device 100 comprises a laser module 102.

The laser module 102 is designed to emit laser light 104 having an adjustable color ratio. The optical device 100 is designed, for example, to generate an image or image content using the laser light 104.

The optical device 100 comprises, for example, a scanner that is designed to generate the image or the image content by scanning with the laser light 104.

In the example, the laser module 102 comprises three differently colored color laser diodes 102a, 102b, 102c. For example, one laser diode is provided for red, green, and blue light, respectively.

The optical device 100 is designed to generate the color ratio through a composition of light generated by the color laser diodes 102a, 102b, 102c.

The optical device 100 comprises a sensor 106 for detecting a light composition of an ambient or scene light. The sensor 106 is, for example, a colorimeter.

The optical device 100 comprises a computing device 108.

The computing device 108 is designed to determine the color ratio of the laser light 104 depending on the light composition.

The computing device 108 is designed to determine the composition depending on the light composition. The computing device 108 is designed, for example, to provide correction data for the composition depending on the light composition.

For example, the optical device 100 comprises a driver 110 for the laser module 102, which driver is designed to adjust the composition depending on the correction data.

For example, the driver 110 is designed to control the corresponding color laser diode 102a, 102b, 102c depending on the correction data for generating the composition.

The optical device 100 is, for example, part of a pair of glasses. The glasses are, for example, data glasses, virtual reality glasses, mixed reality glasses, cycling glasses, diving goggles, safety glasses, or a motorcycle helmet visor.

FIG. 2 shows a flowchart showing steps of a method for adjusting the color ratio of the laser light 104.

It can be provided that the method is carried out while an image or image content is generated by the laser light 104.

It can be provided that the method is carried out per pixel for individual pixels generated by the laser light 104.

The method comprises a step 202.

In step 202, a light composition of an ambient or scene light is detected. The light composition is detected, for example, by the sensor 106.

The method comprises a step 204.

In step 204, the color ratio of the laser light 104 is determined depending on the light composition.

The color ratio is generated by a composition of light generated by at least two different colored color laser diodes. The composition is determined depending on the light composition.

In the example, depending on the light composition, a white point is determined for the composition, the composition by which the laser light 104 can produce the white point being determined.

It can be provided that correction data for the composition are provided depending on the light composition.

For example, to adapt a display generated by light to the environment, correction data achieving a match between the white point of the display and the white point of the environment are provided.

For example, to intentionally distinguish a display generated by light from an environment, correction data achieving a deviation of the white point of the display from the white point of the environment are provided.

The method comprises a step 206.

In step 206, laser module 102 emits laser light 104 having the color ratio.

The laser light 104 is generated by the composition of light generated by at least two color laser diodes.

In the example, the laser light 104 is generated by the composition of light generated by the three color laser diodes 102a, 102b, 102c.

The composition is adjusted depending on the correction data, for example.

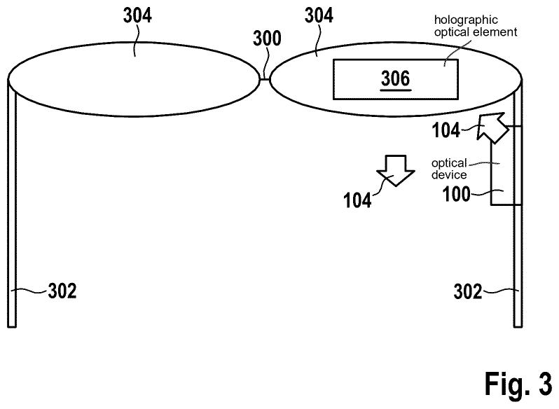

FIG. 3 shows exemplary data glasses 300 having temples 302 and lenses 304. The data glasses 300 comprise the optical device 100. In the example, the optical device 100 is arranged on a temple 302 of the data glasses 300 such that the laser light 104 from the device 100 radiates onto a holographic optical element 306 arranged in one of the lenses 304. The holographic optical element 306 is designed to reflect a portion of the laser light 104 toward an eye of a wearer of the glasses 300. The optical device 100 is designed to generate an image or image content visible to the wearer by scanning the holographic optical element 306 using the laser light 104.

It can be provided that an optical instrument, in particular binoculars, a telescope, a microscope, a periscope, or a device for ophthalmic examinations, comprises the optical device 100. The optical device 100 for the optical instrument is configured, for example, to generate the image or the image portion by scanning an eyepiece of the optical instrument using the laser light 104.

It can be provided that a head-up display, in particular for a vehicle or an aircraft, comprises the display and the optical device 100. The optical device 100 for the head-up display is configured, for example, to generate the image or the image portion by scanning the display using the laser light 104.

The colorimeter can be attached to an outer side or a frame of the optical device 100, in particular the glasses. The colorimeter can comprise two pixels having different color filters. The sensor 106 can comprise an RGB camera. The sensor 106 can comprise a camera in the optical device 100 already provided for other purposes, for example for virtual reality glasses or mixed reality glasses.

The sensor 106 is preferably arranged such that the sensor 106 detects the light composition in a region of the environment of a user in which the image or image portion is displayed for the user of the optical device 100.

The sensor 106 can comprise an eye-tracking camera directed toward the eye of a user of the optical device 100.

The computing device 108 can be designed to estimate the light composition depending on an apparent color of one of the sclera of the user of the optical device, in particular detected by the eye-tracking camera.

What is claimed is:

1. A method for adjusting a color ratio of a laser light, the method comprising:
emitting, by a laser module, laser light having an adjustable color ratio; and
detecting a light composition of an ambient or scene light, wherein the color ratio of the laser light is determined depending on the light composition.

2. The method according to claim 1, wherein the color ratio is generated by a composition of light generated by at least two differently colored color laser diodes arranged in the laser module, the composition being determined depending on the light composition.

3. The method according to claim 2, wherein correction data for the composition are provided depending on the light composition, the composition being adjusted depending on the correction data.

4. The method according to claim 3, wherein: (i) the correction data achieving a match of a white point of a display with a white point of the environment are provided, or (ii) the correction data achieving a deviation of the white point of the display from the white point of the environment are provided.

5. The method according to claim 1, wherein an image or an image content is generated using the laser light.

6. An optical device, comprising:
a laser module;
a sensor configured to detect a light composition of an ambient light or scene light, the sensor including a colorimeter; and
a computing device;
wherein the laser module is configured to emit laser light having an adjustable color ratio, the computing device configured to determine the color ratio of the laser light depending on the light composition.

7. The optical device according to claim 6, wherein the laser module including at least two differently colored color laser diodes, the optical device being configured to generate the color ratio by a composition of light generated by the at least two color laser diodes, and the computing device being configured to determine the composition of the light generated by the at least two color laser diodes depending on the light composition.

8. The optical device according to claim 7, wherein the computing device is configured to provide the correction data for the composition depending on the light composition, the optical device including a driver for the laser module, which driver is configured to adjust the composition of the light generated by the at least two color laser diodes depending on the correction data.

9. The optical device according to claim 6, wherein the optical device is configured to generate an image or an image content using the laser light.

10. Glasses including data glasses, or virtual reality glasses, or mixed reality glasses, or cycling glasses, or diving goggles, or safety glasses, or a motorcycle helmet visor, the glasses comprising:
an optical device including:
a laser module,
a sensor configured to detect a light composition of an ambient light or scene light, the sensor including a colorimeter, and
a computing device,
wherein the laser module is configured to emit laser light having an adjustable color ratio, the computing device configured to determine the color ratio of the laser light depending on the light composition.

11. The optical device according to claim 1, wherein the optical device is part of an optical instrument including binoculars, or a telescope, or a microscope, or a periscope, or a device for ophthalmic examinations.

12. The optical device according to claim 1, wherein the optical device is part of a head-up display for a vehicle or an aircraft.
